(19) United States
(12) Patent Application Publication
(10) Pub. No.: US 2015/0240876 A1
(43) Pub. Date: Aug. 27, 2015

(54) FASTENING ARRANGEMENT TO CONNECT A CAMSHAFT PHASER TO AN END OF A CAMSHAFT

(71) Applicant: Schaeffler Technologies GmbH & Co. KG, Herzogenaurach (DE)

(72) Inventors: Michael Busse, Herzogenaurach (DE); Felicitas Fust, Nuernberg (DE)

(21) Appl. No.: 14/422,331

(22) PCT Filed: May 17, 2013
(86) PCT No.: PCT/EP2013/060255

§ 371 Date: Feb. 18, 2015

(30) Foreign Application Priority Data
Aug. 20, 2012 (DE) 10 2012 214 764.0

(51) Int. Cl. F02B 75/06

(52) U.S. Cl. CPC F16D 1/033; F01L 1/3442

(57) ABSTRACT

A fastening arrangement (1) to connect a camshaft phaser (2) to an end (3) of a camshaft (24) is provided, whereby the camshaft phaser (2) has a hub (4) that is connected to the camshaft end (3) by a fastening screw (5), whereby the hub (4) has an inner conical surface (6) that tapers away from the camshaft phaser (2), and a clamping element (7) is affixed between this inner conical surface (6) and the fastening screw (5), whereby the fastening screw (5) clamps the hub (4) to the camshaft end (3) via the clamping element (7).

The invention relates to a fastening arrangement to connect a camshaft phaser to an end of a camshaft.

### BACKGROUND

Camshaft phasers are used in internal combustion engines in order to vary the timing of the combustion chamber valves so that the phase relation between the crankshaft and the camshaft can be configured variably within a defined angular range between a maximum early position and a maximum late position. Adapting the timing to the current load and rotational speed lowers fuel consumption and reduces emissions. For this purpose, camshaft phasers are integrated into a power train via which a torque is transmitted from the crankshaft to the camshaft. This power train can be configured, for instance, as a belt drive, a chain drive or a gear drive.

In a hydraulic camshaft phaser, the driven element and the drive element form one or more pairs of pressure chambers that counteract each other and that can be pressurized with a hydraulic medium. The drive element and the driven element are arranged coaxially. A movement of the drive element relative to the driven element is generated by filling and emptying individual pressure chambers. The spring, which has a rotational effect between the drive element and the driven element, forces the drive element in a preferential direction relative to the driven element. This preferential direction can be the same as or opposite to the direction of rotation.

One type of hydraulic camshaft phaser is the vane-type adjuster. Vane-type adjusters have a stator, a rotor and a drive wheel with outer toothing. The rotor, as the driven element, is usually configured so that it can be non-rotatably joined to the camshaft. The drive element comprises the stator and the drive wheel. The stator and the drive element are non-rotatably joined to each other or, as an alternative, are configured together in one piece. The rotor is located coaxially to the stator and inside the stator. The rotor and the stator, with their radially extending vanes, form oil chambers that counteract each other, that can be pressurized with oil and that permit a rotation of the stator relative to the rotor. The vanes are either configured in one piece with the rotor or the stator or else they are provided as “inserted vanes” in grooves in the rotor or stator that are provided for this purpose. Moreover, the vane-type adjusters have various sealing covers. The stator and the sealing covers are secured to each other by means of several screwed connections.

Another type of hydraulic camshaft phaser is the axial piston adjuster. Here, oil pressure serves to axially move a sliding element that, by means of slanted toothing, generates a rotation of a drive element relative to a driven element.

Another type of camshaft phaser is an electro-mechanical camshaft phaser, which has triple gearing (for instance, a planetary gear). Here, one of the shafts constitutes the drive element while a second shaft constitutes the driven element. Rotational energy can be supplied to or removed from the system via the third shaft by means of an actuator, for example, an electric motor or a brake. It is possible to additionally arrange a spring that promotes or suppresses the rotation of the drive element relative to the driven element.

German patent application DE 10 2009 051 309 A1 shows a device for camshaft phasing, whereby the hub of the camshaft phaser strikes against a stop element of the camshaft, thereby achieving an axial tensioning between the camshaft phaser and the camshaft via a fastening element. The fastening element is configured here as a clamping nut.

International patent document WO 2007/082600 shows a camshaft phaser that is fastened to a camshaft by means of a central valve. The central valve comprises a control piston that can be moved axially and that is actuated by a central magnet that is positioned flush with it.

European patent application EP 1 544 419 A1 shows a camshaft phaser that is attached to a camshaft using a central screw without a valve function.

### SUMMARY OF THE INVENTION

It is an object of the present invention to provide a fastening arrangement to connect a camshaft phaser to an end of a camshaft, said arrangement permitting a space-saving and reliable fastening of a camshaft phaser to a camshaft.

The present invention provides a fastening arrangement to connect a camshaft phaser to an end of a camshaft, whereby the camshaft phaser has a hub that is connected to the camshaft end by means of a fastening screw. The hub has an inner conical surface that tapers away from the camshaft phaser, and a clamping element is affixed between this inner conical surface and the fastening screw, whereby the fastening screw clamps the hub to the camshaft end via the clamping element.

As a result, when the fastening screw is tightened, the inner conical surface divides the force into a radial force vector and an axial force vector. In order to attain the requisite pretensioning force of the axial force vector as is done in the state of the art, the fastening screw is tightened further, as a result of which it is strained to a greater extent over its length, thus providing the requisite elasticity to counter the settling process that occurs over its service life. The desired pretensioning force can be defined by means of the angle of the inner conical surface. The clamping element is provided for purposes of clamping between the fastening screw and the inner conical surface, and it is widened by the radial force vector during the tensioning of the arrangement. The clamping promotes the torsional strength of the screwed assembly of the fastening arrangement.

The inner conical surface is preferably configured so as to be closed in the circumferential direction although it can be interrupted by recesses such as, for example, grooves or troughs. As an alternative to the inner conical surface, it is also possible to use surfaces having other shapes, for instance, curved surfaces, which can divide the force into an axial force vector and a radial force vector.

In one embodiment of the invention, the clamping element is configured as a ring or sleeve. Preferably, on the outer circumferential surface of the clamping element, there is an outer conical surface that is complementary to the inner conical surface of the hub. The outer conical surface is preferably configured so as to be closed in the circumferential direction although it can be interrupted by recesses such as, for example, grooves or troughs. Moreover, the ring can be closed in the circumferential direction, or else it can be interrupted by a slit, whereby the slit advantageously increases the elasticity of the clamping element. Advantageously, the clamping element is configured as a cone.

Optionally, the clamping element can be configured in one piece with the fastening screw, or else it is present as a component that is separate from the fastening screw. Moreover, the clamping element can be joined positively, non-positively and/or adhesively to the fastening screw in order to facilitate the assembly in that the clamping element is affixed to the fastening screw in a captive manner already before it is joined to the hub.

In an advantageous embodiment, on the inner circumference of the camshaft end, there is an inner conical surface that tapers towards the camshaft phaser, and a threaded ring is affixed between the fastening screw and this inner conical surface. As a result, the end of the camshaft is tubular and it is provided at its end with an open cavity having an inner circumference. The inner circumference itself can have the inner conical surface in that the latter is made in one piece out of the material of the camshaft end. As an alternative, a separate component can be provided which, on its inner circumference, has the inner conical surface and which is joined positively, non-positively and/or adhesively to the camshaft end.

The inner conical surface is preferably configured so as to be closed in the circumferential direction although it can be interrupted by recesses such as, for example, grooves or troughs. As an alternative to the inner conical surface, it is also possible to use surfaces having other shapes, for instance, curved surfaces, which can divide the force into an axial force vector and a radial force vector.

A threaded ring is provided between the inner conical surface of the end of the camshaft and the fastening screw. The threaded ring is preferably affixed to the inner conical surface of the camshaft end in a captive manner before the outer thread of the fastening screw engages with the inner thread of the threaded ring. This fixation can also be implemented by means of a retaining element, for instance, a retaining ring, that is arranged on the widened side of the inner conical surface, whereby the threaded ring is arranged between the retaining element and the tapered side of the inner conical surface. This restricts the freedom of movement of the threaded ring in both axial directions.

In a particularly preferred embodiment, the outer circumferential surface of the threaded ring has an outer conical surface that is complementary to the inner conical surface of the camshaft end. The outer conical surface is preferably configured so as to be closed in the circumferential direction although it can be interrupted by recesses such as, for example, grooves or troughs. Advantageously, the threaded ring is configured as a cone with an inner thread.

In one embodiment of the invention, the fastening screw engages with an inner thread of the threaded ring, as a result of which the clamping element and the threaded ring are tensioned with respect to each other in the axial direction, whereby the clamping element and the threaded ring are spaced at a distance from each other in the axial direction. This spacing can be achieved directly by means of a stop in the axial direction between the hub and the end of the camshaft or else indirectly by means of a separate spacer element. The screwing process causes the clamping element and the threaded ring to first move towards each other, thereby, however, resting on the appertaining inner conical surfaces, which at first are also moved towards each other. Once the stop comes into contact between the hub and the end of the camshaft in the axial direction, the hub rests on the end of the camshaft and prevents any reduction of the distance between the inner conical surfaces and thus also between the clamping element and the threaded ring during the screwing process using the fastening screw. Subsequently, as the screwing process progresses, the fastening screw is strained, bringing about a tensioning of the fastening arrangement.

In a preferred embodiment, the inner conical surface of the camshaft end is formed by a separate component which is joined positively, non-positively and/or adhesively to the camshaft end. At least the separate component is affixed in the axial direction relative to the camshaft end. Fixation in the circumferential direction can be optionally provided. At least the degree of freedom of the separate component in the axial direction is blocked towards the hub, whereby the degree of freedom of the separate component in the axial direction away from the hub can very well exist. Blocking the degree of freedom in the axial direction towards the hub is preferably brought about by a stop between the end of the camshaft and the separate component.

In another embodiment of the invention, the inner conical surface of the camshaft end and the inner conical surface of the hub are spaced at a distance from each other in the axial direction, and a spacer element is arranged in this axial interstice between the inner conical surfaces. The spacer element can be present as a separate component in the form of a ring or a sleeve. As an alternative, the spacer element can be made in one piece out of the camshaft end, the hub, the threaded ring, the clamping element, or else of the separate component which supports the inner conical surface for the camshaft end and which is joined positively, non-positively and/or adhesively to the camshaft end. This spacing can be defined by means of the spacer element, as a result of which a correspondingly long fastening screw can be used whose length, in turn, has an advantageous effect on the tensioning of the fastening arrangement.

In one embodiment of the invention, the spacer element is configured as a separate component. As a separate component in the form of a ring or a sleeve, the spacer element can be simply inserted into the camshaft end before being joined to the hub. Materials having a high modulus of elasticity lend themselves to forming the spacer element and can make a contribution to the elasticity of the screwed assembly, thereby further improving the fastening arrangement. Moreover, springs can be provided as spacer elements or else in addition to the spacer elements, and these springs tension the screwed assembly in the axial direction. Preferably, disc springs can be provided instead of the spacer element or else in addition to the spacer element in the axial direction.

In an advantageous embodiment, the spacer element has a hydraulic medium channel. The hydraulic medium channel can be configured as a radial hole, or axial slit, extending completely along the entire axial length or else only partially along the entire axial length of the spacer element. Moreover, several hydraulic medium channels can be arranged over the circumference either in a regular pattern or else in an irregular pattern, so that no concrete installation position of the spacer element has to be ensured.

In an alternative advantageous embodiment of the invention, the fastening screw is provided with a hydraulic medium channel. This channel can extend axially and centrally through the entire fastening screw. Alternatively, this channel can extend only partially into the fastening screw in the axial direction, either from the side of the screw head or from the thread side, and it can be intersected by a radial hydraulic medium channel.

Owing to the arrangement according to the invention, a fastening arrangement is put forward for joining a camshaft phaser to an end of a camshaft, said arrangement permitting a space-saving and reliable fastening of a camshaft phaser to a camshaft. The invention also makes it possible for the fastening screw to be sunk almost completely in the camshaft end, as a result of which installation space for a central valve becomes available in the axial area of the camshaft phaser.

### BRIEF DESCRIPTION OF THE DRAWINGS

Embodiments of the invention are shown in the figures.

The following is shown:

FIG. 1 a first embodiment of the fastening arrangement according to the invention;

FIG. 2 a second embodiment of the fastening arrangement according to the invention;

FIG. 3 a third embodiment of the fastening arrangement according to the invention;

FIG. 4 a fourth embodiment of the fastening arrangement according to the invention;

FIG. 5 a fifth embodiment of the fastening arrangement according to the invention, with a spacer element;

FIG. 6 a sixth embodiment of the fastening arrangement according to the invention, with a spacer element; and

FIG. 7 a seventh embodiment of the fastening arrangement according to the invention, with a spacer element.

### DETAILED DESCRIPTION

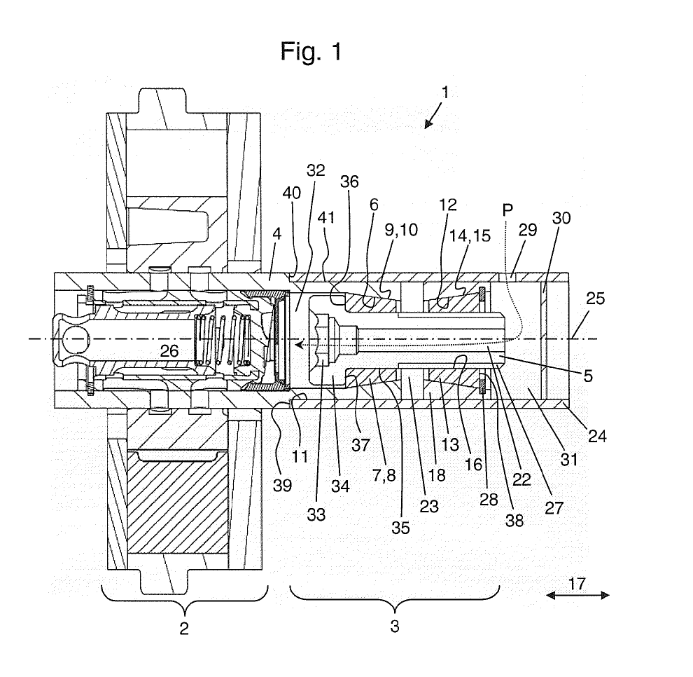

FIG. 1 shows a first embodiment of the fastening arrangement 1 according to the invention.

The fastening arrangement 1 has a hub 4 of a camshaft phaser 2 that is non-rotatably joined to an end 3 of a camshaft 24. Furthermore, the fastening arrangement 1 has a clamping element 7 configured as a ring 8 as well as a threaded ring 13. The camshaft end 3 is configured in one piece with the camshaft 24. All of the components are arranged coaxially to the rotational axis 25 of the fastening arrangement.

The hub 4 of the camshaft phaser 2 projects out of the camshaft phaser 2 and into the camshaft end 3. A cylindrical outer circumferential surface 41 of the hub 4 is in contact with a cylindrical surface section of the inner circumference 11 of the end 3 of the camshaft, as a result of which the hub 4 is oriented coaxially with respect to the camshaft end 3. The hub 4 has a face 40 that is arranged axially between the outer circumferential surface 41 and the camshaft phaser 2. In the axial area of the outer circumferential surface 41, there is an inner conical surface 6 that tapers away from the camshaft phaser 2 and that ends with the delimiting surface of the hub 4 at the end facing the camshaft. The inner conical surface 6 is in contact with an outer conical surface 10 that is complementary to it and it is in contact with the outer conical surface 10 that is formed by the outer circumferential surface 9 of the ring 8. The face 36 of the ring 8 facing the camshaft phaser 2 is in contact with the face 37 of the screw head 34 of the fastening screw 5. The fastening screw 5 passes through the ring 8 as well as through the inner conical surface 6 of the hub 4. The ring 8 is accommodated by the screw shank 35 of the fastening screw 5, as a result of which the fastening screw 5 and the ring 8 are oriented coaxially to each other. A central valve 26 is positioned axially inside the camshaft phaser 2 to the greatest extent possible, whereby a cavity 32 is formed between the central valve 26 and the screw head 34.

The end 3 of the camshaft 24 has a separate component 18 which is fastened positively, non-positively and/or adhesively to the inner circumference 11 and which has an inner conical surface 12 and is arranged so as to be axially fixed relative to the camshaft end 3. This inner conical surface 12 is in contact with an outer circumferential surface 14 of the threaded ring 13 configured as an outer conical surface 15. The inner conical surface 12 tapers in the axial direction 17 towards the camshaft phaser 2. A retaining ring 28 is fastened positively to the separate component 18 in order to axially secure the position of the threaded ring 13 with respect to the separate component 18. The retaining ring 28 is in contact with a face 38 of the threaded ring 13. In the axial direction 17, the screw shank 35 is followed by an outer thread 27 that engages with the inner thread 16 of the threaded ring 13. Here, the outer thread 27 of the fastening screw 5 passes completely through the threaded ring 13. The hub 4 with the separate component 18 as well as the ring 8 with the threaded ring 13 are each spaced at an axial distance from each other, thus forming an interstice 23.

Moreover, the fastening screw 5 has a hexagon socket 33 which is formed by the screw head 34 and via which the fastening screw 5 can be screwed into the fastening arrangement 1 and into the threaded ring 13.

The fastening arrangement 1 can be assembled, for example, in the following manner: a first assembly comprises the camshaft 24 with the end 3 and the fastened separate component 18 that axially affixes the threaded ring 13 by means of the retaining ring 28. The second assembly comprises the camshaft phaser 2 with its hub 4. The central valve 26, the ring 8 and the fastening screw 5 are at first separate from the first and second assemblies. First of all, the second assembly is joined to the first assembly, whereby the hub 4 is inserted into the cavity of the camshaft end 3. Subsequently, the ring 8—optionally after being previously joined to the fastening screw 5—is inserted into the hub 4. The fastening screw 5 is screwed to the threaded ring 13 until the pairs of conical surfaces come into contact with each other. A continued screwing procedure then tensions the fastening arrangement 1. To finalize the process, the central valve 26 is inserted into the hub 4.

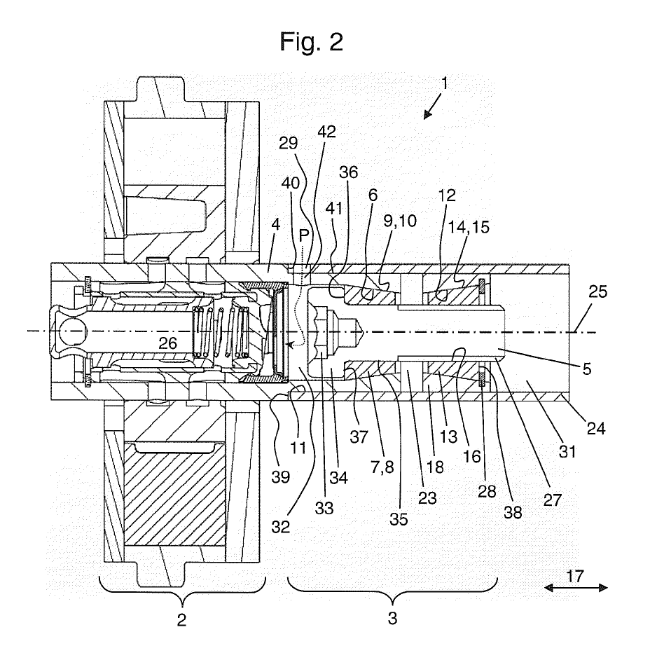

The configuration of the fastening arrangement 1 described so far here is also shown in the subsequent FIGS. 2 to 7. Individual special features of the individual figures will be elaborated upon below.

In addition to the above-mentioned basic structure, FIG. 1 has as a radial hole 29 and a separating element 30 as another special feature of the hydraulic-medium line. Together with the separate component 18, the threaded ring 13 and the end of the fastening screw 5 on the thread side, the separating element 30 forms a cavity 31 in the camshaft 24. The hole 29 of the camshaft 24 connects the cavity 31 to a feed connection P. Moreover, the fastening screw 5 has a hydraulic-medium channel 22 which is arranged coaxially to the rotational axis 25 and which is formed as a through-hole. Therefore, in order to operate the camshaft phaser 2, hydraulic medium can be conveyed starting from the feed connection P via the hole 29 into the cavity 31, through the hydraulic-medium channel 22 of the fastening screw 5 through the fastening arrangement 1 to the cavity 32, from where the hydraulic medium is available to the central valve 26 in order to operate the camshaft phaser 2.

The fastening arrangement 1 is configured so as to be tensioned in order to non-rotatably transfer torque from the camshaft phaser 2 to the camshaft 24. The tensioning is brought about by the screwed connection of the fastening screw 5. When the fastening screw 5 is tightened, the axial distance from the ring 8 to the threaded ring 13 is reduced. The ring 8 and the threaded ring 13 rest via their outer conical surfaces 10 and 15 on the appertaining inner conical surfaces 6 and 12. Furthermore, the end face 39 of the camshaft end 3 rests on the face 40. Due to the two pairs of conical surfaces and the axial length of the fastening screw 5, the elasticity in the screwed assembly is increased, thereby achieving a high pretensioning force of the screwed assembly, which has a positive effect on the service life and reliability of the fastening arrangement 1.

FIG. 2 shows a second embodiment of the fastening arrangement according to the invention.

As an alternative to the special feature of the hydraulic-medium line described in FIG. 1, FIG. 2 has a radial hole 29 that is positioned axially inside the outer circumferential surface 41. A hole 42 of the hub 4 is situated opposite from the hole 29, thereby forming a fluid-conveying connection between the cavity 32 and the feed connection P. In this manner, in order to operate the camshaft phaser 2, hydraulic medium can be conveyed starting from the feed connection P via the holes 29 and 42 into the cavity 32, from where the hydraulic medium is available to the central valve 26 in order to operate the camshaft 2.

Analogously to the embodiment in FIG. 1, the fastening arrangement 1 is configured so as to be tensioned in order to non-rotatably transfer torque from the camshaft phaser 2 to the camshaft 24. The tensioning is brought about by the screwed connection of the fastening screw 5. When the fastening screw 5 is tightened, the axial distance from the ring 8 to the threaded ring 13 is reduced. The ring 8 and the threaded ring 13 rest via their outer conical surfaces 10 and 15 on the appertaining inner conical surfaces 6 and 12. Furthermore, the end face 39 of the camshaft end 3 rests on the face 40. Due to the two pairs of conical surfaces and the axial length of the fastening screw 5, the elasticity in the screwed assembly is increased, thereby achieving a high pretensioning force of the screwed assembly, which has a positive effect on the service life and reliability of the fastening arrangement 1.

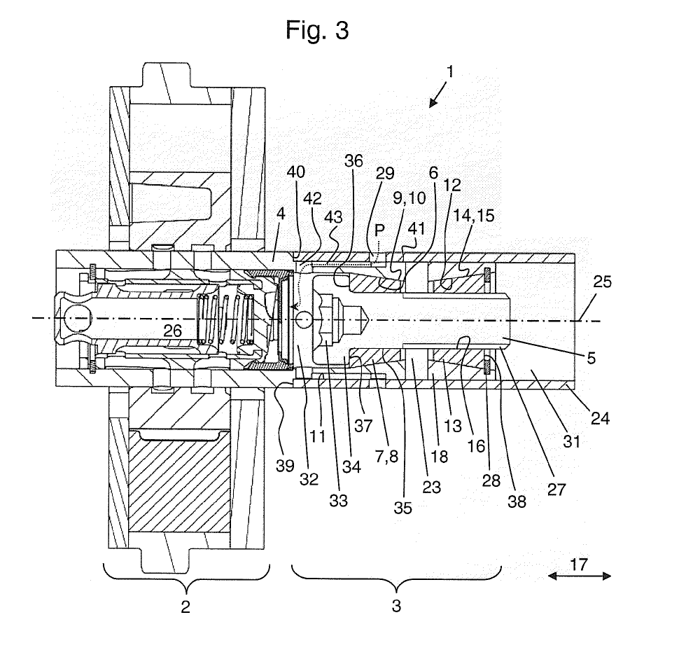

FIG. 3 shows a third embodiment of the fastening arrangement according to the invention.

As an alternative to the special feature of the hydraulic-medium line described in FIG. 1, FIG. 3 has a radial hole 29 that is positioned axially inside the outer circumferential surface 41.

Here, in contrast to the embodiment according to FIG. 2, the hole 29 is not situated opposite from the hole 42 of the hub 4, but rather, the holes 29 and 42 are arranged axially at a distance from each other. Both holes 29 and 42 are connected in a fluid-conveying manner by a hydraulic-medium channel 43 that is formed by the outer circumferential surface 41, preferably as an axial groove, thereby forming a fluid-conveying connection between the cavity 32 and the feed connection P. In this manner, in order to operate the camshaft phaser 2, hydraulic medium can be conveyed starting from the feed connection P via the holes 29 and 42 into the cavity 32, from where the hydraulic medium is available to the central valve 26 in order to operate the camshaft phaser 2.

Analogously to the embodiment in FIG. 1, the fastening arrangement 1 is configured so as to be tensioned in order to non-rotatably transfer torque from the camshaft phaser 2 to the camshaft 24. The tensioning is brought about by the screwed connection of the fastening screw 5. When the fastening screw 5 is tightened, the axial distance from the ring 8 to the threaded ring 13 is reduced. The ring 8 and the threaded ring 13 rest via their outer conical surfaces 10 and 15 on the appertaining inner conical surfaces 6 and 12. Furthermore, the end face 39 of the camshaft end 3 rests on the face 40. Due to the two pairs of conical surfaces and the axial length of the fastening screw 5, the elasticity in the screwed assembly is increased, thereby achieving a high pretensioning force of the screwed assembly, which has a positive effect on the service life and reliability of the fastening arrangement 1.

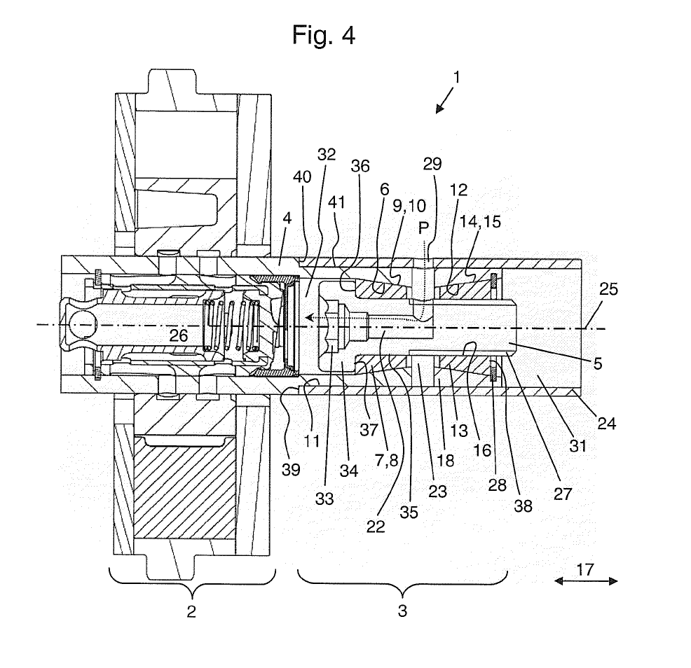

FIG. 4 shows a fourth embodiment of the fastening arrangement according to the invention.

As an alternative to the special feature of the hydraulic-medium line described in FIG. 1, FIG. 4 has a radial hole 29 that is arranged in the axial area of the interstice 23.

The hole 29 of the camshaft 24 connects the interstice 23 to a feed connection P. Moreover, the fastening screw 5 has a hydraulic-medium channel 22 which is arranged coaxially to the rotational axis 25 but which is angled in the interstice 23 and which consists of two blind holes arranged at an angle relative to each other. In this manner, in order to operate the camshaft phaser 2, hydraulic medium can be conveyed starting from the feed connection P via the hole 29 into the interstice 23, through the hydraulic-medium channel 22 of the fastening screw 5 into the cavity 32, from where the hydraulic medium is available to the central valve 26 in order to operate the camshaft phaser 2.

Analogously to the embodiment in FIG. 1, the fastening arrangement 1 is configured so as to be clamped in order to non-rotatably transfer torque from the camshaft phaser 2 to the camshaft 24. The tensioning is brought about by the screwed connection of the fastening screw 5. When the fastening screw 5 is tightened, the axial distance from the ring 8 to the threaded ring 13 is reduced. The ring 8 and the threaded ring 13 rest via their outer conical surfaces 10 and 15 on the appertaining inner conical surfaces 6 and 12. Furthermore, the end face 39 of the camshaft end 3 rests on the face 40. Due to the two pairs of conical surfaces and the axial length of the fastening screw 5, the elasticity in the screwed assembly is increased, thereby achieving a high pretensioning force of the screwed assembly, which has a positive effect on the service life and reliability of the fastening arrangement 1.

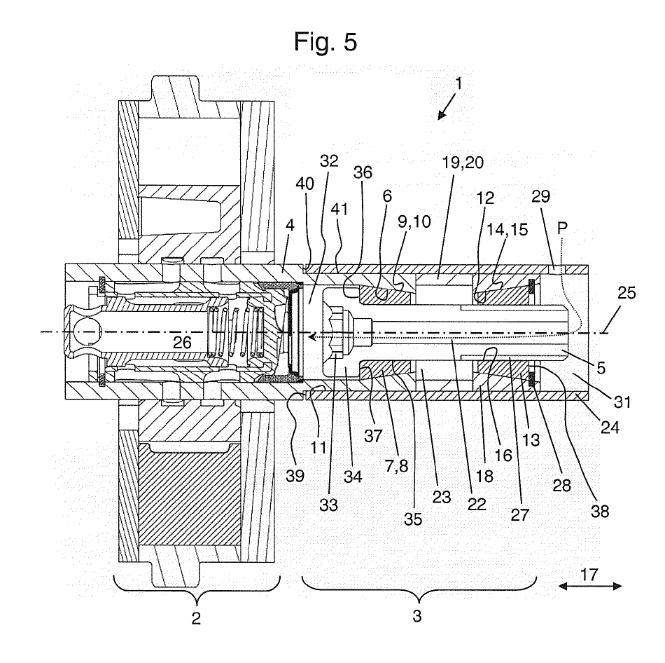

FIG. 5 shows a fifth embodiment of the fastening arrangement according to the invention.

FIG. 5 has the same basic structure as the hydraulic-medium line in FIG. 1, except for the separating element 30, which is no longer present here.

The hole 29 of the camshaft 24 connects the cavity 31 to a feed connection P. Moreover, the fastening screw 5 has a hydraulic-medium channel 22 which is arranged coaxially to the rotational axis 25 and which is configured as a through-hole. In this manner, in order to operate the camshaft phaser 2, hydraulic medium can be conveyed starting from the feed connection P via the hole 29 into the cavity 31, through the hydraulic-medium channel 22 of the fastening screw 5 through the fastening arrangement to the cavity 32, from where the hydraulic medium is available to the central valve 26 in order to operate the camshaft phaser 2.

As an alternative to the fastening arrangement 1 according to FIG. 1, here a spacer element 19 is placed as a separate component 20 axially between the hub 4 and the separate component 18. Diverging from FIG. 1, here the end face 39 of the camshaft end 3 no longer rests on the face 40. An axial gap is provided between the faces 39 and 40. This support function is now fulfilled by the spacer element 19. By the same token as in FIG. 1, the two pairs of conical surfaces and the axial length of the fastening screw 5 increase the elasticity of the screwed assembly, thereby achieving a high pretensioning force of the screwed assembly, which has a positive effect on the service life and reliability of the fastening arrangement 1. Towards this end, the spacer element 19 can be advantageously configured so as to have geometric properties that further enhance the elasticity in the screwed assembly.

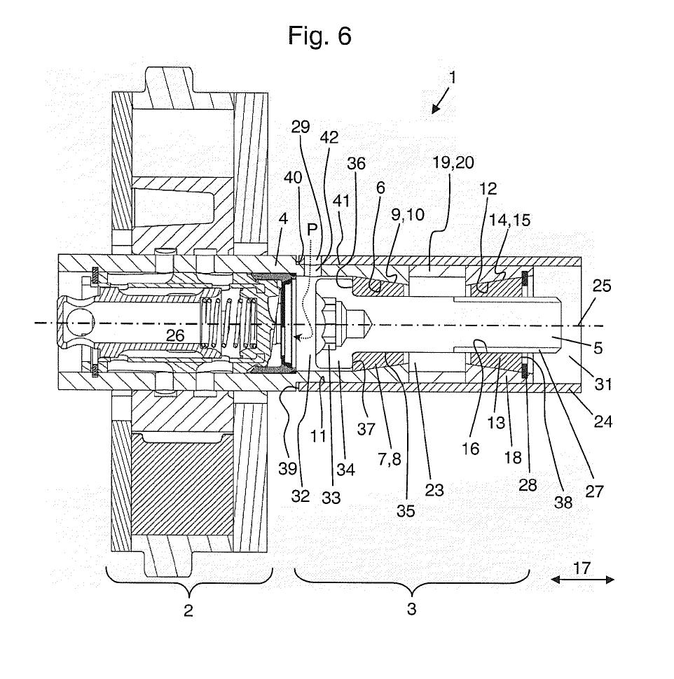

FIG. 6 shows a sixth embodiment of the fastening arrangement according to the invention, with a spacer element.

FIG. 6 has the basic structure of the hydraulic-medium line as shown in FIG. 2.

The radial hole 29 is positioned axially inside the outer circumferential surface 41. A hole 42 of the hub 4 is situated opposite from the hole 29, thereby forming a fluid-conveying connection between the cavity 32 and the feed connection P. In this manner, in order to operate the camshaft phaser 2, hydraulic medium can be conveyed starting from the feed connection P via the holes 29 and 42 into the cavity 32, from where the hydraulic medium is available to the central valve 26 in order to operate the camshaft 2.

As described in FIG. 5, here a spacer element 19 is placed as a separate component 20 axially between the hub 4 and the separate component 18. Diverging from FIG. 1, here the end face 39 of the camshaft end 3 no longer rests on the face 40. An axial gap is provided between the faces 39 and 40. This support function is now fulfilled by the spacer element 19. By the same token as in FIG. 1, the two pairs of conical surfaces and the axial length of the fastening screw 5 increase the elasticity of the screwed assembly, thereby achieving a high pretensioning force of the screwed assembly, which has a positive effect on the service life and reliability of the fastening arrangement 1. Towards this end, the spacer element 19 can be advantageously configured so as to have geometric properties that further enhance the elasticity in the screwed assembly.

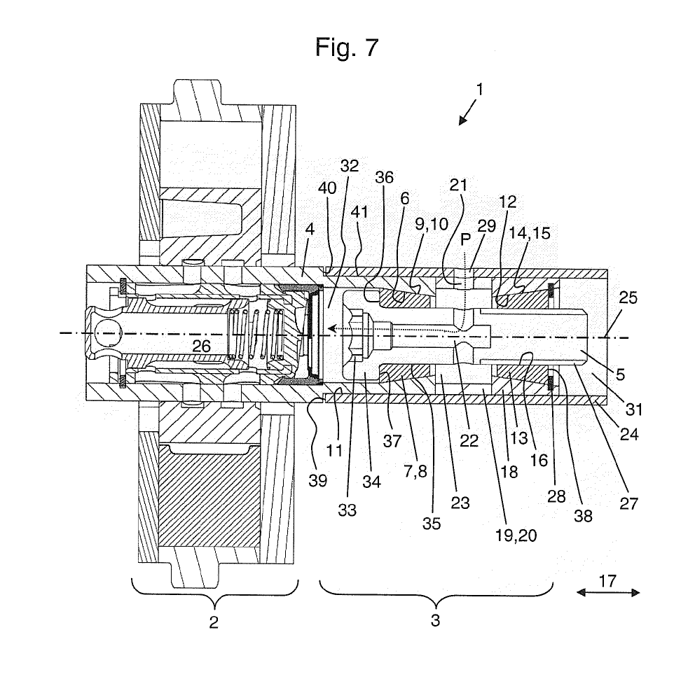

FIG. 7 shows a seventh embodiment of the fastening arrangement according to the invention, with a spacer element.

FIG. 7 has the same basic structure as the hydraulic-medium line shown in FIG. 4.

The radial hole 29 is arranged in the axial area of the interstice 23. The hole 29 of the camshaft 24 connects the interstice 23 to a feed connection P. Moreover, the fastening screw 5 has a hydraulic-medium channel 22 which is arranged coaxially to the rotational axis 25 but which intersects in the interstice 23 and which consists of two holes arranged at an angle relative to each other, whereby the axial hole is configured as a blind hole that is intersected by a continuous crosswise hole which, in turn, opens up into the interstice 23. In this manner, in order to operate the camshaft phaser 2, hydraulic medium can be conveyed starting from the feed connection P via the hole 29 into the interstice 23 through the hydraulic-medium channel 22 of the fastening screw 5 into the cavity 32, from where the hydraulic medium is then available to the central valve 26 in order to operate the camshaft phaser 2.

As described in FIG. 5, here a spacer element 19 is placed as a separate component 20 axially between the hub 4 and the separate component 18. Diverging from FIG. 1, here the end face 39 of the camshaft end 3 no longer rests on the face 40. An axial gap is provided between the faces 39 and 40. This support function is now fulfilled by the spacer element 19. By the same token as in FIG. 1, the two pairs of conical surfaces and the axial length of the fastening screw 5 increase the elasticity of the screwed assembly, thereby achieving a high pretensioning force of the screwed assembly, which has a positive effect on the service life and reliability of the fastening arrangement 1. Towards this end, the spacer element 19 can be advantageously configured so as to have geometric properties that further enhance the elasticity in the screwed assembly.

### LIST OF REFERENCE NUMERALS

1 fastening arrangement
2 camshaft phaser
3 camshaft end
4 hub
5 fastening screw
6 inner conical surface
7 clamping element
8 ring
9 outer circumferential surface
10 outer conical surface
11 inner circumference
12 inner conical surface
13 threaded ring
14 outer circumferential surface
15 outer conical surface
16 inner thread
17 axial direction
18 separate component
19 spacer element
20 separate component
21 hydraulic-medium channel
22 hydraulic-medium channel
23 interstice
24 camshaft
25 rotational axis
26 central valve
27 outer thread
28 retaining ring
29 hole
30 separator
31 cavity
32 cavity
33 hexagon socket
34 screw head
35 screw shank
36 face
37 face
38 face
39 face
40 face
41 outer circumferential surface
42 hole
43 hydraulic-medium channel
P feed connection

1-10. (canceled)

11. A fastening arrangement to connect a camshaft phaser to an end of a camshaft, comprising:
a fastening screw connecting a hub of the camshaft phaser to the camshaft end, the hub having an inner conical surface tapering away from the camshaft phaser; and
a clamping element affixed between the inner conical surface and the fastening screw, the fastening screw clamping the hub to the camshaft end via the clamping element.

12. The fastening arrangement as recited in claim 11 wherein the clamping element is configured as a ring and an outer circumferential surface of the clamping element is provided with an outer conical surface complementary to the inner conical surface of the hub.

13. The fastening arrangement as recited in claim 11 wherein on the inner circumference of the camshaft end an inner conical surface tapers towards the camshaft phaser, and a threaded ring is affixed between the fastening screw and the inner conical surface.

14. The fastening arrangement as recited in claim 13 wherein the outer circumferential surface of the threaded ring is provided with an outer conical surface complementary to the inner conical surface of the camshaft end.

15. The fastening arrangement as recited in claim 13 wherein the fastening screw engages with an inner thread of the threaded ring so that the clamping element and the threaded ring are clamped with respect to each other in the axial direction, the clamping element and the threaded ring being spaced at a distance from each other in the axial direction.

16. The fastening arrangement as recited in claim 13 wherein the inner conical surface of the camshaft end is formed by a separate component joined positively, non-positively or adhesively to the camshaft end.

17. The fastening arrangement as recited in claim 13 wherein the inner conical surface of the camshaft end and the inner conical surface of the hub are spaced at a distance from each other in the axial direction to define an axial interstice, and a spacer element is arranged in the axial interstice between the inner conical surfaces.

18. The fastening arrangement as recited in claim 17 wherein the spacer element is configured as a separate component.

19. The fastening arrangement as recited in claim 17 wherein that the spacer element has a hydraulic medium channel.

20. The fastening arrangement as recited in claim 11 wherein the fastening screw has a hydraulic medium channel.
